(19) United States
(12) Patent Application Publication
(10) Pub. No.: US 2009/0203277 A1
(43) Pub. Date: Aug. 13, 2009

(54) CLOTHING FOR USE ON MACHINES FOR PRODUCING MATERIAL WEBS IN THE FORM OF PAPER WEBS, PAPERBOARD WEBS OR TISSUE WEBS AND METHODS FOR MANUFACTURING A PAPER MACHINE CLOTHING

(76) Inventors: Robert Crook, Wilson, NC (US); Cliff Wilder, Sims, NC (US)

Correspondence Address: TAYLOR & AUST, P.C., P.O. Box 560, 142. S Main Street, Avilla, IN, 46710, US

(21) Appl. No.: 12/361,108

(22) Filed: Jan. 28, 2009

Related U.S. Application Data
(60) Provisional application No. 61/027,166, filed on Feb. 8, 2008.

(51) Int. Cl. B32B 27/40; B05D 3/02

(52) U.S. Cl. 442/164; 427/195

(57) ABSTRACT

A clothing and method for producing the clothing, for use on machines for producing material webs in the form of paper webs, paperboard webs or tissue webs, in particular a press belt or transfer belt with a porous composite structure, comprising at least one layer, which forms the surface supporting the material web, and particulate polymer material, whereby, after thermal activation, the particulate polymer material is partly melted and bonded to the structure forming the layer so that said structure is partly impregnated and voids in the structure are partly filled. The clothing is characterized in that the particulate material is partially differently distributed in the region of the surface supporting the material web over the width direction of the clothing.

### CROSS REFERENCE TO RELATED APPLICATIONS

This is a non-provisional application based upon U.S. provisional patent application Ser. No. 61/027,166, entitled “PRESS FABRIC WITH ENGINEERED PROFILE”, filed Feb. 8, 2008, which is incorporated herein by reference.

### BACKGROUND OF THE INVENTION

1. Field of the Invention

The present invention relates to a clothing, and method for producing such a clothing, for use on machines for producing material webs in the form of paper webs, paperboard webs or tissue webs, in particular a press belt or transfer belt with a porous composite structure, including at least one layer which forms the surface supporting the material web and particulate polymer material.

2. Description of the Related Art

Clothings for use in the wet part of a machine for producing a fibrous web in the form of a paper web, paperboard web or tissue web, in particular in a press section, are known from the prior art. Such clothings are used to guide and support the fibrous web during the dewatering process in the press section. The running direction of the material web through the press section is defined in this case by the machine direction (MD). Usually such clothings have uniform air and/or water permeability profiles transverse to the machine direction (MD). It is a disadvantage in the art that the material web fed to a press section of a paper machine is often characterized in practical applications by a non-uniform distribution of moisture in the transverse direction so that, considered transverse to the machine direction, the treatment of such a material web can result in an ineffective dewatering and change of form of the material web. This negatively influences the quality of the material web, in particular, it may establish an unfavorable transverse profile, which can result in properties of the end product which differ over its width.

To address this issue, publication EP 1 674 613 A1 discloses a paper machine clothing, in particular in the form of a press felt, which has different properties transverse to the machine running direction. The proposed paper machine clothing has a thread arrangement which is orientated solely in the machine running direction, whereby said arrangement is constructed such that regions with different fluid permeability are constructed transverse to the machine running direction in order to adapt the dewatering properties of the paper machine clothing to the different moisture profile in the transverse direction of the material web. A possible embodiment provides for the density of the individual threads to vary transverse to the machine direction. This variation must be taken into account and already be worked into the structure when the structure is being manufactured.

Versions of press felts containing polymer particles mixed with fibers are known from publication EP 1 757 728 A1 and publication US 2007/0155269 A1. The mixing of polymer particles with fibers is performed in this case with a fleece lamination which may be formed from any material, for example, from nylon fibers or similar materials of any cross section which form synthetic fibers. The layer to be applied includes a polymer in which solid bodies and preferably staple fibers are embedded. The layer is produced by applying a suspension, including at least one polymer and either at least the solid bodies and/or the staple fibers, onto the surface of the fleece lamination and then heating the polymer. The layer is thus applied in one work step as a type of polymer mix of polymer particles and fibers, whereby the degree of mixing influences the distribution.

From publication WO 2004/085727 there is known a clothing which includes a fleece lamination which may be optionally pinned to a base ply. During the manufacturing of the industrial clothing, a dispersion of particulate polymer material is applied onto a layer of the fleece lamination and thermally activated in order to form an inhomogeneous layer containing a mixture of fiber fleece fibers and a polymer fiber fleece matrix. This layer, which is not predefined geometrically, is constructed in the X, Y and Z direction within the fiber fleece lamination.

What is needed in the art is a clothing which satisfies the high requirements imposed on the surface quality of material webs conveyed therewith and is also specifically adaptable to the moisture profile of the material web to be conveyed. The manufacturing method should be characterized by little outlay and the clothing should be adaptable for use on already existing felt belts.

### SUMMARY OF THE INVENTION

The present invention provides a clothing for use on machines for producing material webs in the form of paper webs, paperboard webs or tissue webs, in particular a press belt or transfer belt with a porous composite structure. The clothing of the present invention contains at least one layer which forms the surface supporting the material web and particulate polymer material, whereby the particulate polymer material, after thermal activation, is partly melted and bonded to the layer-forming structure such that the structure is partly impregnated and voids in the structure are partly filled. The clothing of the present invention is characterized in that the partly melted polymer material bonded to the layer-forming structure is arranged in the region of the surface supporting the material web only in at least one predefined region when viewed in the width direction of the clothing, meaning that the polymer material is arranged only partially in the region of the surface supporting the material web over the width direction of the clothing when viewed in the width direction.

The clothing of the present invention provides, by simple means, in particular by the application of particulate material and subsequent thermal activation, a way to modify and establish the transverse profile of a clothing, in particular a press belt with regard to its permeability such that the belt can be optimally adapted, permanently or at least temporarily, to the moisture transverse profile of the fibrous web to be picked up and conveyed. The random arrangement of particles permits in this case the selectability of any cross-sectional profile, in particular with regard to permeability.

If the partly melted polymer material bonded to the layer-forming structure extends only partly into the layer forming the surface supporting the material web, then the effect created is only superficial and does not penetrate the entire structure. The particulate polymeric material may extend, for example, 0.75 mm, 0.5 mm, or 0.25 mm from the layer forming the surface supporting the material web into the layer.

In principle, a multiplicity of embodiments of the present invention are possible. Common to all is that they have, viewing in the width direction of the industrial clothing, at least one first zone with particulate material in the region of the surface and at least one second zone free of particulate or partly melted polymer material bonded to the layer-forming structure. The partly melted polymer material bonded to the layer-forming structure wets and impregnates the surface and the structures forming said surface, and penetrates at least partly into the surface-forming structure. The particles are either completely embedded or impregnate the structure-forming components, for example, fibers. However, the arrangement is such that it does not change the basic structure of the surface-forming structure. For this purpose, the particulate polymers do not form a continuous layer, but only layer regions. For example, only approximately 1% to approximately 70%, for example, approximately 5% to approximately 50%, of the total volume of the structure forming the surface is penetrated with the particulate polymer material.

According to one embodiment, the first zones can be formed by the edge regions, when viewed in the width direction of the industrial clothing, which are characterized by a width in the direction of the middle of the industrial clothing, looking in the width direction. The region in between is free of partly melted polymer material bonded to the layer-forming structure in the region of the upper area of the clothing. As the result, an adaptation to the different moisture profile over the fibrous web width is achieved in the critical regions, namely the regions of the side edges. As a result of the obtained properties, it is possible to improve the adhesion capacity in particular for picking up the fibrous web from the former onto a press belt. The edge regions of the clothing are characterized by a width in the range of 5 cm to 150 cm, preferably in the range of 10 cm to 100 cm.

According to another embodiment it is possible, dependent on the condition of the surface-forming layer, for at least one first zone to be provided in the regions free of the edge regions and for the second zones to be formed by the edge regions.

With regard to obtaining the requisite transverse profile in order to guarantee the required permeabilities and surface smoothness, there are a multiplicity of possibilities which can also be combined. For example, it is possible to provide, within one of the first zones, for an unchanging distribution of the particulate material in the normal state and for the resultant distribution, after thermal activation, of the partly melted polymer material bonded to the layer-forming structure in the thickness direction (TD) and/or longitudinal direction or machine direction (MD).

According to an alternative embodiment it is also possible to provide for a different distribution of the partly melted polymer material, which is bonded to the structure forming the layer, in the vertical direction and/or longitudinal direction or machine direction MD. The distribution can be effected constantly or differently over the width. The particles to be applied also vary in the directions mentioned, in particular in size and geometrical shape, in addition to the amount of particles.

In the normal state, at the time of application, the individual particles of the particulate material forming the polymer material regions can be characterized by a different particle geometry and/or size. The depth of penetration can thus be varied along with the surface effect achievable with the particles. According to one embodiment, particle sizes of the particulate material in the range from 30 to 200 μm, 30 to 150 μm, or 50 to 150 μm are used. Alternatively, or in addition to the aforementioned, particulate polymer material having a particle size in the range of 1 μm or less may be used.

The partly melted polymer material bonded to the layer-forming structure contains at least one thermoplastic polymer material, for example, thermoplastic elastomer polymer, or thermoplastic elastomer polyurethane. As the result, heating-induced melting with regions of the surface-forming structure is possible.

The present invention is advantageous in press belts or transfer belts. The layer forming the surface supporting the material web is formed by a fiber fleece structure in order to increase the dimensional stability, the fleece structure being pinned to a base layer, whereby the base layer is free of particulate polymer material. The fiber fleece structure includes a multiplicity of fleece layers which are characterized by different degrees of fiber fineness.

The layer forming the surface supporting the material web can also be formed according to another embodiment by a polymer layer which extends over the surface of a fiber fleece structure.

The method for manufacturing the industrial clothing of the present inventions is characterized by the following process steps:
Providing a layer forming a surface supporting a material web, the layer having a plurality of zones;
Providing particulate polymer material;
Applying a particulate polymer material in the width direction of the industrial clothing in predefined zones viewed from the width direction
Effecting an at least partial, controlled penetration of the particulate polymer material into the surface-forming layer; and
Thermally activating the particulate polymer material in order to construct a porous composite structure in which the particulate material is partly melted and bonded to the layer-forming structure so that the structure is partly impregnated and voids in the structure are partly filled.

The method for manufacturing the industrial clothing of the present invention is very easy to perform and can be used, without influencing the basic structure, even on already finished clothings so that the clothings can be profiled. The particulate polymer material may be applied in the edge regions of the clothing, when viewed in the width direction, over a predefined width from the respectively opposite end regions toward the middle, because these are the critical regions.

The application of the polymer material may be controlled in order to obtain the desired transverse profile in the width direction with regard to at least one of the following variables:
Application quantity;
Application density;
Particle geometry; and/or
Particle size,

Depending on the version of the applicator, the variables can be established with little outlay.

The application may be performed in the form of a dispersion. This provides a simple equalizing means, for example, by using an equalizing apparatus.

If the layer forming the surface supporting the material web is a component of a porous composite structure which includes a fiber fleece structure, whereby the particulate polymer is applied onto the surface of the fiber fleece structure, then the effecting step can be greatly influenced by the fineness of the fibers in the fleece structure and/or by the particle size of the particulate polymer material.

According to another embodiment, a sucking in of the particulate polymer material into the fiber fleece structure can be effected by applying a vacuum in order to support the penetration into the surface-forming structure. The thermal activation is assured by heating.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1a to 1c illustrate, with reference to different sectional representations by way of example, arrangements and distributions of the partly melted polymer material bonded to the lamination-forming structure;

FIG. 1d illustrates a further aspect according to FIG. 1c;

FIG. 2 illustrates an alternative arrangement of the profiling as per FIG. 1a;

FIGS. 3a and 3b illustrate, with reference to two views, an apparatus for creating the inventive profiling of a clothing;

FIG. 3c illustrates by way of example, a possibility for realizing the selectability of the transverse profile of the clothing;

FIG. 4 illustrates, with reference to a signal flowchart, the sequence of method for creating a profiled structure.

Corresponding reference characters indicate corresponding parts throughout the several views. The exemplifications set out herein illustrates embodiments of the invention and such exemplifications are not to be construed as limiting the scope of the invention in any manner.

### DETAILED DESCRIPTION OF THE INVENTION

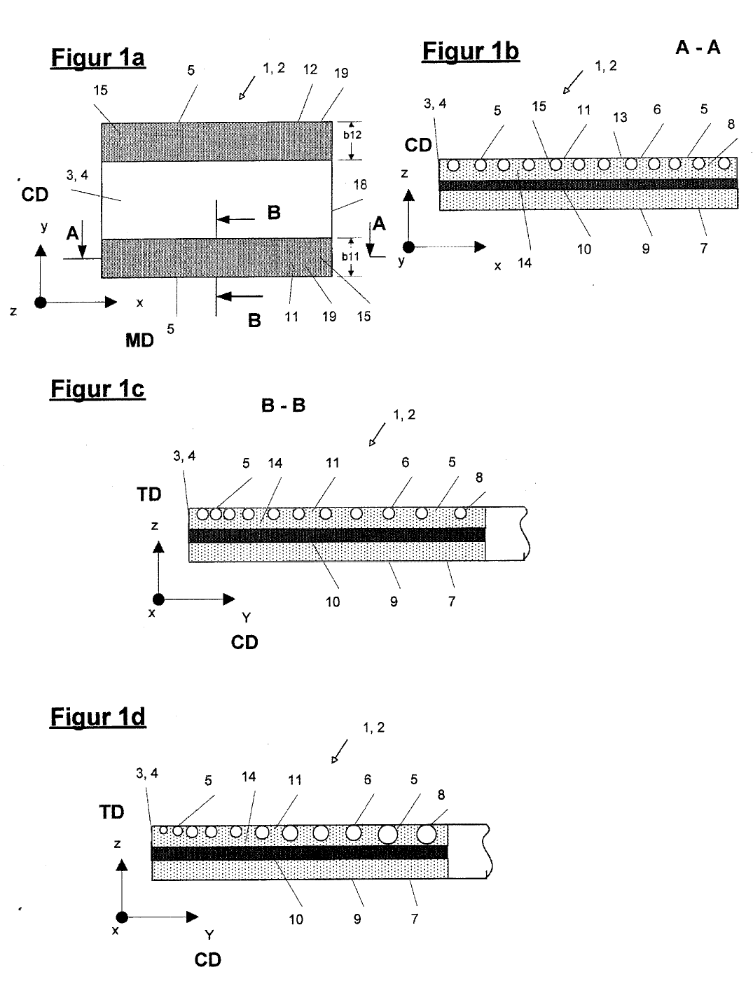

Referring now to the drawings and more particularly to FIGS. 1a to 1c, there is shown, in a schematically simplified representation and with reference to details, different views of inventively constructed clothing 1 according to a first embodiment. The embodiment is, in particular, a clothing for use in a wet section of a machine for producing material webs, in particular fibrous webs in the form of paper webs, paperboard webs or tissue webs. Here, clothing 1 is constructed as press felt 2. The felt includes porous composite structure 3, which has a fleece structure, in particular a fiber fleece structure and, in the normal state, particulate polymer material 5′, which after thermal activation no longer exists in particle form and is bonded to the structure forming layer or lamination 8 so that said structure is partly impregnated and voids in the structure are partly filled. Polymer material 5 forms, in this case, polymer material regions, but no closed coating.

FIG. 1a illustrates a view of clothing 1 from above after thermal activation of particulate polymer material 5′ is completed. Evident from FIG. 1, which takes reference to an XYZ coordinate system, is the extension, during use on machines for producing fibrous webs, in the longitudinal direction of the machine, which is also called the MD direction and corresponds to the X direction according to the applied coordinate system, and the extension in the width direction, meaning transverse to the machine direction MD, which here is called the cross direction CD and describes the Y direction. Fiber fleece structure 4 has upper face 6 and, opposite upper face 6, lower face 7, the faces being orientated inverse to each other and spaced apart from each other in the thickness direction TD. Fiber fleece structure 4 includes at least one fleece layer, preferably two fleece layers, in this case fleece layers 8 and 9. The layers enclose on both sides base layer 10, which, depending on the version, is also called the basic layer or the base fabric. Base layer 10 forms the carrier for fleece layers 8 and 9. Also conceivable are more fleece layers which can be used as intermediate fleece layers between fleece layers 8 and 9 and base layer 10. The concrete selection depends in this case on the requirements of use and is left to the judgment of those skilled in the art.

Prior to applying particulate polymer material 5′ in the normal state (not shown here), fiber fleece structure 4 was pinned to base layer 10. Polymer material 5′ is applied, according to the first embodiment, respectively transverse to the machine direction MD, meaning in the cross direction CD, in at least a predefined region, in this case edge regions 11 and 12 at both sides of clothing 1, which may form an endlessly circulating belt. Edge regions 11 and 12 are characterized by extension b₁₁ and b₁₂ from the outermost sides of clothing 1 respectively in the direction of the middle. Partly melted polymer material 5 bonded to layer 8 forming the structure extends into the edge regions. Clothing 1 is thus equipped in the width direction only partially with polymer material 5 in the region of upper face 6. The regions beyond are free of polymer material on upper face 6.

FIG. 1b illustrates by way of example, a sectional representation of a view A-A in the edge region 11. From FIG. 1b it is evident that polymer material 5 does not penetrate fully into fiber fleece layer 8 or fleece structure 4, but is joined partly to fibers 13 which extend on upper face 6 of fiber fleece structure 4 and to fibers 14 in the inside of fiber fleece structure 4 so that, in order to form porous composite structure 3, polymer material 5 partly impregnates fibers 13 to 14 of fleece structure 4, partly fills voids between the fibers and, in addition, partly extends in the height direction relative to the fibers beyond the lamination on upper face 6.

For better clarity, polymer material regions 5 in FIG. 1b are rendered in idealized form with regard to their geometrical shape. The formation of polymer material regions 5, which are continuous but do not completely coat and do not evenly penetrate the predefined region, takes place after the thermal activation of the particles.

It is evident from FIG. 1b that profiling 15 on the upper side or upper face 6 may be created essentially evenly in the longitudinal direction, meaning the MD direction during use on machines for producing fibrous webs, in edge regions 11 and 12 in order to obtain an even transverse profile over the entire length of the material web. On the other hand, FIG. 1c illustrates a view B-B according to FIG. 1a, which is likewise idealized with regard to the polymer material regions forming from the particulate polymer materials after thermal activation, from which the progression and the distribution in edge region 11 or 12, in this case 11 by way of example, in the width direction are evident. From this it is evident that the distribution in the width direction can vary in the predefined region in the form of edge region 11, as the result of which a different dewatering profile is obtained in the width direction over edge region 11.

The predefined regions with particulate material form, when viewed in the width direction, first zones 19 while the regions free of particulate materials form second zones 18.

According to FIG. 1d, the arrangement presented in FIG. 1c is realized in addition with different particle sizes.

The regions formed from the polymer material in the state of being melted and impregnating layer 8 have a particle size from 20 to 200 μm, for example, approximately 120 μm.

A thermoplastic elastomer, for example polyurethane, is used as polymer material 5. After the thermal activation of particle material 5, the material is then melted and bonded at least partly to the structure forming upper face 6.

To obtain the desired properties, composite structure 3 in fiber fleece structure 4 has a changing amount of polymer material 5 in the width direction. In addition, it is also possible for the amount of polymer material 4 in the thickness direction TD to be respectively variable looking in the width direction.

In the case illustrated, the porosity of composite structure 3 varies in the width direction, in particular between edge regions 11, 12 and the rest of clothing 1. In addition it is also possible, depending on the distribution and construction, to vary the porosity in the thickness direction. FIG. 1c illustrates an embodiment on which particles, which may be, of identical size, are applied in the width direction, but in different amounts and with a different density and different distance from each other so that a corresponding distribution of the polymer material over the width of the clothing is established in the predefined regions after thermal activation.

On the embodiments shown in FIGS. 1a to 1d, only the upper side is impregnated and equipped with the polymer material. Depending on the type of aftertreatment it is possible to obtain a rough or very smooth surface 6 which forms the side conveying the paper web.

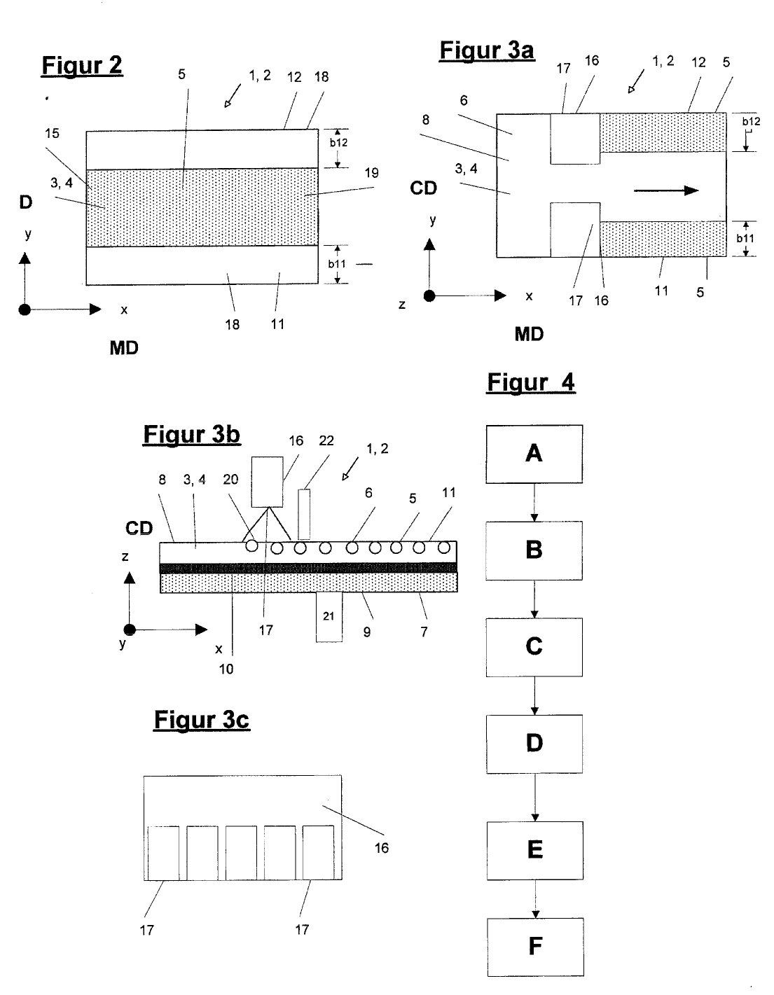

FIG. 2 illustrates, in the light of a view according to FIG. 1a looking from above onto industrial clothing 1, another possible embodiment on which polymer material 5 is arranged, looking in the width direction, solely in the region of the center of clothing 1. Edge regions 11 and 12 are free of polymer material 5 and thus, form second zones 18, while first zone 19 with polymer material 5 is provided solely in a region in the middle of clothing 1. This embodiment represents another possible construction. However, the concrete construction depends on the concrete requirements of use and on the condition of clothing 1 to be obtained transverse (CD) to the running direction MD of the material web.

With regard to the construction of base layer 10, there are many different possibilities. In the easiest case the base layer is a fabric. Other carriers are likewise conceivable.

FIGS. 3a and 3b illustrate, in a schematic simplified representation, an inventive method for producing function surface 6 by applying and embedding polymer material 5 in the form of particles. As previously explained, the individual particles can be characterized by either the same particle size, composition and condition or they can be differently constructed according to the property selected for the surface. This also applies with regard to the distribution of said particles, in particular looking in the width direction Y or the CD direction of clothing 1.

According to another embodiment, it is also possible to obtain a corresponding variability in the thickness direction TD.

FIG. 3a illustrates clothing 1, in particular fiber fleece structure 4 with upper face 6 and lower face 7, in a view from above. Fiber fleece structure 4 is pinned to the base layer. The entire arrangement of the composite structure is moved in the longitudinal direction X or the machine direction MD relative to applicator unit 16. Applicator unit 16 comprises at least one dispensing device 17 for dispensing particulate polymer material 5′ onto upper face 6 of fiber fleece structure 4. The material can be dispensed in the form of dispersion 20 or, depending on the construction of the element forming surface 6, in solid form. In the illustrated case with fleece structure 4 having upper fleece layer 8, particulate polymer material 5′ is applied in the form of dispersion 20 onto fleece structure 4. In this case dispensing device 17 is arranged, according to a view from above shown, by way of example in FIG. 3a, only in edge regions 11, 12, whereby by way of example, the slit width or nozzle width is accordingly variable over width b₁₁, b₁₂ of edge regions 11, 12 in order to be able to apply different amounts of dispersion. In addition it is conceivable to use single outlet nozzles such as are shown by way of example in FIG. 3c in a schematic and simplified representation. In this case individual dispensing devices 17, which as a rule are constructed as nozzles, can be set individually or in groups.

In addition, a controlled setting of the amount of polymer material along the width direction can be effected, when viewed in the width direction, by setting the outlet conditions on the individual nozzles or respective outflow gap and/or the size of applicable polymer material 5. Provision can be made in addition under fiber fleece structure 4 for suction device 21 which sucks applied polymer material 5 into fiber fleece structure 4. The suction device is arranged preferably directly underneath applicator unit 16 or immediately following it in the vertical direction. Offsetting clothing 1 or fiber fleece structure 4 in conveying direction is likewise possible. If a vacuum is applied here, the particulate polymer materials 5 can be sucked in. After dispersion 20 is applied, the particles can be distributed, in particular equalized. This is not absolutely necessary however. Presented here, by way of example, is equalizer 22. The equalizer is preferably designed such that, looking over the width, a corresponding gradient is obtained in the edge region.

In this case, individual edge regions 11 and 12 can be coated with corresponding particle material 5 either simultaneously or in succession. The advantage of simultaneous treatment is that the thermal activation can also be performed simultaneously for both regions. In this case, applicator unit 16 has two dispensing devices 17, whereby each of dispensing devices 17 includes a multiplicity of elements which form individual outlet gaps and are arranged side by side transverse to the machine direction, whereby the conditions at the outlet are selectable.

After the equalizing, particulate polymer material 5 is thermally activated and thus forms composite structure 3 in which polymer material 5, which in the normal state exists as particles, is partly melted and joined to the fibers so that it impregnates the fibers of fleece layer 8 at least partly and also partly fills voids and produces a profile on the upper face 6. The thermal activation can be followed in addition by a smoothing process, for example, a calendering process. Depending on the aftertreatment, surface 6 can be designed to be rougher to more even.

FIG. 4 illustrates the procedure by taking reference to a signal flowchart. Process step A entails providing fiber fleece structure 4, process step B entails setting applicator unit 16. Applying the polymer material, in this case at least in edge regions 11 and 12, follows in process step C, and equalizing follows in process step D. Thermal activation takes place in process step E for the purpose of melting the particulate polymer material. During process step E, the structure is treated with a temperature of, for example, approximately 160°-200° C., preferably 180° C., over a duration of between 1 min and 5 min, preferably 2 min. Together with the temperature treatment, compacting the structure or surface treatment may occur simultaneously under process step E. The structure produced in the preceding steps is cooled under process step F.

An embodiment of clothing 1 in the form of a removal felt is characterized, for example, in that fleece layer 8 forming surface 6 has a degree of fineness of 6.7 dtex. Particulate material 5′ is applied thereto symmetrically on both sides in the edge regions 11 and 12 and thermally activated. The width of edge regions is approximately 30″. The density of the polymer material equals 100 gsm.

What is claimed is:

1. A clothing for use on a machine for producing a fibrous web, said clothing comprising a porous composite structure, said composite structure comprising:
at least one layer having a surface supporting the material web; and
particulate polymer material having individual particles, said polymer material is thermally activated and partly melted and bonded to said at least one layer such that said layer is at least partially impregnated with said partly melted particulate polymer material and voids of said layer being at least partially filled when viewed in a width direction of said clothing with said partly melted particulate polymer material;
wherein said partly melted particulate polymer material is arranged only in at least one predefined region of said layer providing said surface supporting the material web when viewed in a width direction of said clothing.

2. The clothing according to claim 1, wherein said clothing is one of a press belt and a transfer belt.

3. The clothing according to claim 1, wherein said polymer material at least partly penetrates said at least one layer having a surface supporting the material web.

4. The clothing according to claim 2, further comprising at least one first zone and at least one second zone when viewed in the width direction, said at least one first zone including said partly melted particulate polymer material and said at least one second zone including substantially no polymer material.

5. The clothing according to claim 4, further comprising edge regions having a constant width and a middle region arranged between said edge regions when viewed in the width direction, wherein said at least one first zone is formed by said edge regions and said at least one second zone is formed by said middle region.

6. The clothing according to claim 4, wherein said at least one first zone includes no edge regions and said at least one second zone is formed by said edge regions.

7. The clothing according to claim 6, wherein said edge regions have a width in the range between 5 cm and 150 cm.

8. The clothing according to claim 7, wherein said partly melted particulate polymer material is distributed substantially uniformly in said at least one first zone when viewed in a thickness direction of the clothing and one of a longitudinal direction of the clothing and a machine direction of the clothing.

9. The clothing according to claim 7, wherein said partly melted particulate polymer material is not distributed uniformly in said at least one first zone when viewed in a thickness direction of the clothing and one of a longitudinal direction of the clothing and a machine direction of the clothing.

10. The clothing according to claim 9, wherein said partly melted particulate polymer material is substantially evenly distributed in said first zone when viewed in a width direction.

11. The clothing according to claim 9, wherein said partly melted particulate polymer material is not substantially evenly distributed in said first zone when viewed in a width direction.

12. The clothing according to claim 1, wherein said individual particles of said particulate polymer material have a first state prior to thermal activation, said individual particles being identical in at least one of particle geometry and size in said first state.

13. The clothing according to claim 11, wherein said individual particles of said particulate polymer have a first state prior to thermal activation, said individual particles having at least one of a different particle geometry and a different size in said first state.

14. The clothing according to claim 13, wherein said individual particles of said particulate polymer material being in said first state are arranged with identical particle density when viewed in a width direction of the clothing.

15. The clothing according to claim 13, wherein said particulate polymer material has a particle size in said first state lying in a range from 30 to 200 μm.

16. The clothing according to claim 15, wherein said particulate polymer material has a particle size in said first state lying in a range from 30 to 150 μm.

17. The clothing according to claim 16, wherein said particulate material has a particle size in said first state in a range from 50 to 150 μm.

18. The clothing according to claim 17, wherein said particulate polymer material includes a thermoplastic polymer material.

19. The clothing according to claim 18, wherein said particulate polymer material includes a thermoplastic elastomer polymer material.

20. The clothing according to claim 19, wherein said particulate polymer material includes a thermoplastic elastomer polyurethane.

21. The clothing according to claim 20, further comprising a fiber fleece structure and a base layer having no polymer material being bonded to the belt forming said at least one layer, said fiber fleece structure being pinned to said base layer.

22. The clothing according to claim 21, wherein said fiber fleece structure has a multiplicity of fleece layers, each of said fleece layers having a different degree of fiber fineness.

23. The clothing according to claim 20, further comprising a fiber fleece structure and a polymer layer, said at least one layer having a surface supporting the material web being formed by said polymer layer extending over a surface of said fiber fleece structure.

24. A method for manufacturing an industrial clothing, the method comprising:
providing a layer having a plurality of zones, said layer forming a surface supporting a material web;
providing a particulate polymer material having individual particles;
applying said particulate polymer material in a width direction of the industrial clothing in at least one of said plurality of zones of said layer when viewed in a width direction;
effecting an at least partial penetration of said particulate polymer material into said layer, said penetration being controlled; and
thermally activating said particulate polymer material to form a porous composite structure by melting and bonding said particulate polymer material to said layer, said layer being at least partly impregnated and said voids of said layer being at least partly filled with said particulate polymer material.

25. The method for manufacturing the industrial clothing of claim 24, wherein said effecting step includes applying a vacuum to suck a dispersion of the particulate polymer material into a fiber fleece structure.

26. The method for manufacturing an industrial clothing of claim 25, wherein the step of applying said particulate polymer material in a width direction is controlled by at least one of application quantity, application density, particle geometry and particle size.

27. The method for manufacturing the industrial clothing of claim 26, further comprising the step of applying said particulate polymer material in the form of at least one dispersion.

28. The method for manufacturing the industrial clothing of claim 27, wherein said at least one dispersion contains particles having different sizes over a width of the clothing.

29. The method of manufacturing the industrial clothing of claim 28, further comprising the step of applying said particulate polymer material onto a surface of a fiber fleece structure
